(19) United States
(12) Patent Application Publication
(10) Pub. No.: US 2017/0205685 A1
(43) Pub. Date: Jul. 20, 2017

(54) METHOD AND SYSTEM FOR PHOTOGRAPHIC LIGHTING

(71) Applicant: PHOTOTECHNICA INC., Kitchener (CA)

(72) Inventor: Christopher Jerome GERGLEY, Toronto (CA)

(73) Assignee: Phototechnica Inc., Kitchener, ON (CA)

(21) Appl. No.: 15/508,901

(22) PCT Filed: Sep. 14, 2015
(86) PCT No.: PCT/CA2015/000490

§ 371 Date: Mar. 3, 2017

Related U.S. Application Data
(60) Provisional application No. 62/050,150, filed on Sep. 14, 2014.

(51) Int. Cl. G03B 15/06; H04N 5/225; F21V 7/04; F21V 13/08; F21V 9/08; F21V 7/06

(52) U.S. Cl. CPC G03B 15/06; F21V 9/08; F21V 7/06; F21V 7/043; F21V 13/08; H04N 5/2256

(57) ABSTRACT

There is disclosed a spectrally multiplexed lighting system for photography and video. In an embodiment, the system comprises a first filter adapted to selectively pass a first spectrum of light emitted from at least one light source along a first light path; and a second filter adapted to selectively pass a second spectrum of light emitted from the at least one light source along a second light path; wherein, the first and second filters produce at least two spectrally distinct light streams along the first light path and the second light path, each light stream having different lighting characteristics. In another embodiment, the system includes an optional light source, and a reflector for reflecting at least a portion of light emitted from the at least one light source to emit light along the first and second light paths to produce at least two spectrally distinct light streams having different lighting characteristics in a self-contained light fixture.

### FIELD

The present application relates generally to lighting and capture systems for photography and video. More particularly, the present application relates to a lighting system for use with capture systems for photography and video.

### BACKGROUND

Photographic lighting may have many qualities and characteristics. It is possible to set up a studio and control the qualities of the lighting, which can be made to vary according to desired parameters. Types of lighting commonly used to make aesthetically pleasing and technically competent photographs can range from soft and diffuse to hard and direct, or from warm to cool, or from any direction or combination of directions. In addition, lighting can be adapted to the nature of the object to be photographed. For example, if the object is moving its position, its motion can be made to appear still in the image capture by a short duration flash of bright light.

A photographic light source that is typically described as soft or diffuse requires the source to be large and near in relation to objects being lit, and may also emit or scatter light in multiple directions from the source. An image said to have soft light will typically have light that surrounds the object being photographed and results in even illumination with little or no visible shadows. This is typically achieved by modifying the light from a smaller light source by passing the light through a larger semi-transparent material or bouncing the light against a larger reflective surface or panel. Both methods may achieve varying levels of softness depending on the amount of light scatter caused by semi-transparent material or surface properties of the reflector, as well as the size of either material or reflector.

A photographic light source that is typically described as hard requires the light source to be small or distant in relation to the objects being lit. The light becomes more parallel and directional the further the source is from the object. An image said to have hard light will typically have light that strikes the object being photographed from a single direction and creates sharp and distinct shadows. This is typically achieved by using a light with a small source and may be enhanced by optics to provide even more parallel light or a smaller aperture for light to pass through.

Photography outside of the studio has many lighting options and resources. For example, on camera flash can compensate for low light conditions and also freeze motion. Desirable lighting may be achieved by the manipulation and arrangement of lights, reflectors, screens, scrims, masks, baffles, filters, lenses, timers and other kinds of apparatus. Lighting has to be arranged before the shot is taken and it cannot be changed after the shot is taken. Today there are many digital tools to alter, improve and work with photographs. Photographs may be cropped, lightened or darkened in part or overall, their color and contrast may be adjusted, details may be removed, two or more images may be combined either wholly or in part, flaws may be corrected to some extent, but the actual lighting itself and its respective shadows, glare or relative brightness to other lights cannot be changed after image capture has been made.

Therefore, what is needed is an improved lighting method and system for photography and video which may provide additional lighting options for capture, and post capture processing.

### SUMMARY

The present disclosure describes a method and system for lighting for capturing two or more photographic lighting conditions captured in a single shot through a spectrally multiplexed lighting system. Each spectrally specific channel is configured for a corresponding channel on the capture device. This may include a single typical RGBG Bayer or CMY Sensors, or a dedicated capture device with multiple sensors or beam splitters with filters matched to the specific spectral characteristics of the lighting system and its corresponding filters. The discrete channels may then be edited separately or mixed in various ways. The channels may be averaged, blended, toggled between, or further processed by computer in part or in whole.

The disclosure describes a lighting fixture to enable two lighting conditions to be captured in a single shot or frame. This fixture can take a variety of forms. It is one component in a system that may include existing capture devices (cameras) or custom designed capture devices.

This disclosure also describes a capture system for photography or video which allows the capture of two or more spectrally distinct lighting conditions such that they can be independently edited, and/or combined, blended, averaged or otherwise computed and manipulated to produce aesthetic effects, and to enable photographic functions.

In a first aspect, the present disclosure provides a system in which two or more distinct kinds of lighting may be prepared, and after a shot is taken, a user may select between the different kinds of lighting, or combine them in a desired proportion. This can be accomplished by making the different kinds of lighting spectrally distinct through the use of filters, or through the use of phosphors designed to emit light in specified wavelengths.

In a further aspect, any colored filter can restrict or define the spectral range of a beam of light. This disclosure includes dichroic or interference filters, which can be manufactured to pass a specific and sharply defined band of wavelengths. The disclosure can also make use of any kind of filter that achieves the same effect as a dichroic or interference filter.

In a further aspect, the precise wavelengths of light passed by the filters may depend on the particular sensitivity range of the camera sensors used to make the image.

In a further aspect, the present disclosure describes embodiments for capture with matched filters on multiple sensors and embodiments for capture with common Bayer RGB filters.

Other aspects and features of the present disclosure will become apparent to those ordinarily skilled in the art upon review of the following description of specific embodiments in conjunction with the accompanying figures.

### BRIEF DESCRIPTION OF THE DRAWINGS

FIG. 1 shows a schematic diagram of a light fixture in accordance with an illustrative embodiment.

FIG. 1a shows a schematic block diagram of a light fixture in accordance with another illustrative embodiment.

FIG. 1b shows a schematic block diagram of a light fixture in accordance with another illustrative embodiment.

FIG. 1c shows a schematic block diagram of a light fixture in accordance with yet another illustrative embodiment.

FIG. 2 shows a diagram of a studio setup in which a light fixture in accordance with an illustrative embodiment is used.

FIG. 3 shows a diagram of an on camera flash adaption of a light fixture in accordance with another illustrative embodiment.

FIG. 4 shows a diagram of an on camera flash adaption if a light fixture in accordance with yet another illustrative embodiment.

FIG. 4a shows a diagram of an on camera flash adaption of light fixture in accordance with still another illustrative embodiment.

FIG. 5 shows a detailed diagram of a duplex light fixture in accordance with another illustrative embodiment.

FIG. 5a shows a diagram of an alternative embodiment including two light sources facing opposite directions in accordance with another illustrative embodiment.

FIG. 6 shows a schematic graph illustrating the distribution of wavelength bandpass segments on dichroic or interference filters in accordance with an illustrative embodiment.

### DETAILED DESCRIPTION

Generally, the present disclosure provides a method and system for lighting for capturing two or more lighting conditions for photography or video through a spectrally multiplexed lighting system.

The lighting system can take a variety of forms and configuration, as will be detailed below. Different embodiments of a light fixture which may be a component in the lighting system and may be used with capture devices (cameras) or custom designed capture devices are also described.

In an embodiment, the lighting method and system generates at least two spectrally specific channels, where each channel is configured for a corresponding channel on the capture device. This may include a single typical RGBG Bayer or CMY Sensors, or a dedicated capture device with multiple sensors or beam splitters with filters matched to the specific spectral characteristics of the lighting system and its corresponding filters. The discrete channels may then be edited separately or mixed in various ways—averaged, blended, toggled or other computations and operations.

In another embodiment, the system may include a capture system for photography which allows the capture of two or more spectrally distinct lighting conditions such that they can be independently edited, and/or combined, blended, averaged or otherwise computed and manipulated to produce aesthetic effects, and to enable photographic functions.

In a first aspect, the present method and system creates two or more distinct kinds of lighting to light a subject, and after a shot of the object is taken, a user may select between the different kinds of lighting captured simultaneously, or combine them in a desired proportion. This can be accomplished by making the different kinds of lighting spectrally distinct through the use of filters, or through the use of phosphors designed to emit light in specified wavelengths.

In a further aspect, any colored filter can restrict or define the spectral range of a beam of light. This disclosure includes dichroic or interference filters, which can be manufactured to pass a specific and sharply defined band of wavelengths. The disclosure can also make use of any kind of filter that achieves the same effect as a dichroic or interference filter.

In a further aspect, the precise wavelengths of light passed by the filters may depend on the particular sensitivity range of the camera sensors used to make the image.

In a further aspect, the present disclosure describes embodiments for capture with matched filters on multiple sensors and embodiments for capture with common Bayer RGB filters.

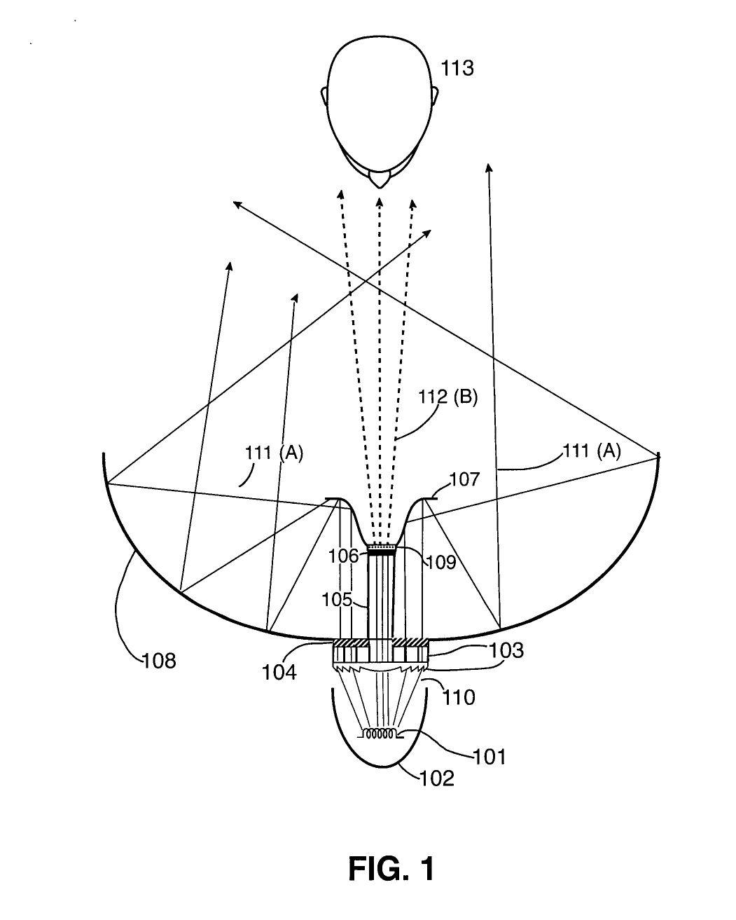

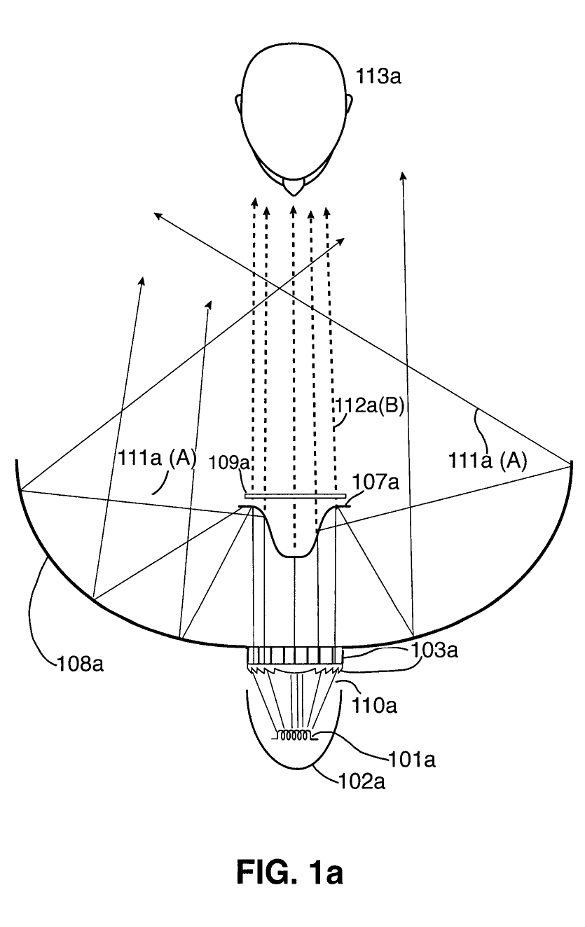

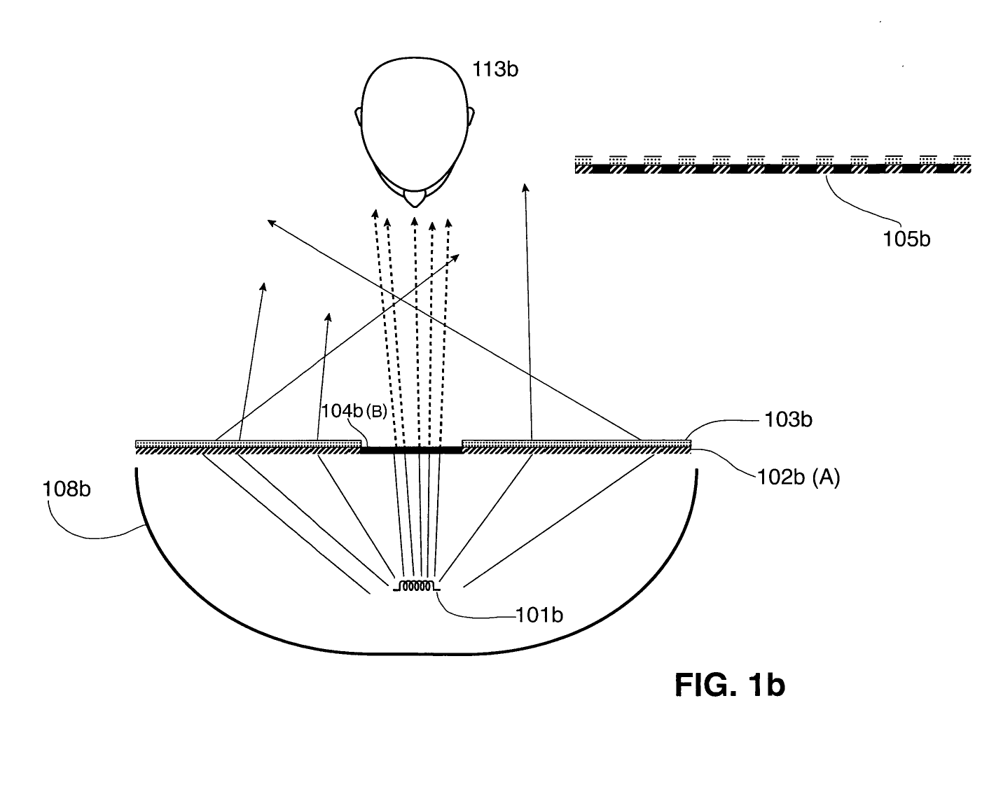

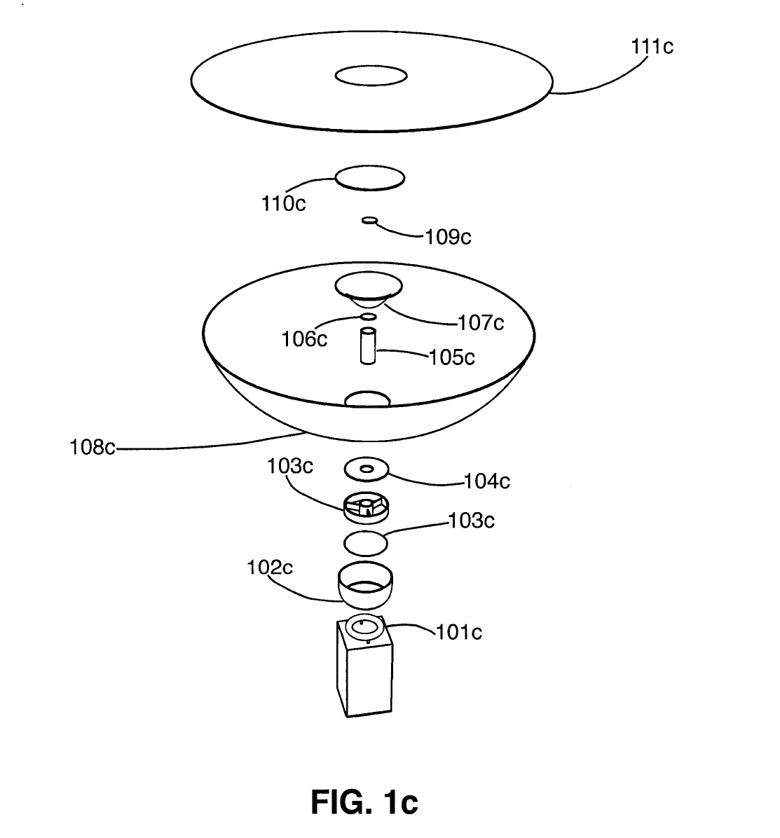

In an embodiment, the system may be configured to produce multiple single channel monochrome photographs with a single RGB filtered sensor, or multiple multichannel color photographs with beam splitter and multiple RGB filtered sensors with corresponding and matched multiband filters. Photographs that may be edited as described above may be taken by a system using ordinary cameras and the lighting system described above in FIG. 1. The lighting system works by directing light through filters that divide it into spectrally distinct channels. The light in each channel is then given a different quality. These qualities might include hard/soft, warm/cool, direct/indirect or any number of qualities for commercial or amateur photography. The light source may be a tungsten filament, a fluorescent tube, a xenon flash tube, HMI lamp, LED lamp a single phosphor or group of phosphors, or any other source. The light source may be built into the device or the entire fixture may be adapted to fit an external light source or placed in the path of natural sunlight. The spectral division of the light may be accomplished with a lighting fixture or multiple lighting fixtures using elements that may include but are not restricted to: filters of diverse kinds including dichroic and/or interference filters and diffusion filters, custom lenses, specially designed baffles to collimate the light, and specially shaped reflectors. The following describes a possible configuration of the system, a single lighting fixture that divides the light into two spectral bands and gives the resulting different channels desired characteristics.

Various illustrative embodiments of the method and system will now be described with reference to the drawings. However, it is to be understood that the invention is not limited in its application to the details of construction and arrangements of components set forth in the following illustrative example, and that the invention is capable of alternative embodiments and of being practiced or being carried out in various ways. Also, it is to be understood that the terminology used herein is for the purpose of illustrative description and should not be regarded as limiting.

FIG. 1 describes a lighting fixture in accordance with an embodiment. The light source may be a tungsten filament, a fluorescent tube, a xenon flash tube, HMI lamp, LED lamp a single phosphor or group of phosphors, or any other source. A reflector 108 used by photographers to diffuse and soften light, made such that light 101 placed behind the reflector 108 passes through a hole in the base, is supplied with a smaller parabolic reflector 107 to re-reflect the light back onto the main reflector 108. The reflector 108 may be of any size or material. It may be rigid or collapsible. The large opening or face of reflector 108 from which the light is emitted may be round, square, octagonal or any other shape to provide a particular character of light. The reflector 107 may reflect all of or a portion of the filtered or unfiltered light from the light source. In the embodiment this parabolic reflector 107 is a parabolic reflector open at both ends attached at the smaller end to a tube or cylinder 105. A torus or doughnut shaped dichroic or interference filter 104, called the Filter A, set to pass light with specific spectral characteristics of Filter A, is fitted over the hole in the base of the main reflector 108, and the tube 105 is fitted over the central hole in Filter A. The top end of the tube 105, where it joins the parabolic reflector 107, supports a dichroic or interference filter 106, called the second filter, set to pass a narrow band of light in the Filter B area of the spectrum. The light source 101 is fixed behind the reflector so the light passes through the hole in the base and hence through both first and second filters 104 & 106. For the filters 104 & 106 to function efficiently the angle of incidence of the light is specified, and all beams of light entering the filter are parallel. In the embodiment, the angle of incidence may be zero. To enable this, the light source 101 may have a built in reflector 102 that collimates the light. Behind the hole in man reflector 108 and in front of the light 101 is a collimator or collimating assembly 103 that may include either or both a collimating lens and set of baffles to restrict the angle of the beam of light. The collimator collimates the light to ensure that it strikes the two filters 104&106 at a zero angle of incidence. The light 112 passing through the smaller filter B 106 in the middle of the apparatus is highly directional and narrowly focused. This kind of light may be described as hard. The light passing through Filter A 104 is reflected off the central parabolic reflector 107 onto the body of the larger reflector 108 and then into space, producing a broad and highly diffuse light 111. This kind of light may be described as soft. The hard light 112 passing through Filter B 106 may be spread to some degree to make it useful for normal photographic purposes. This is accomplished by a diffusion filter or beam spreader 109 placed on top of Filter B 106. The collimating assembly 103 and reflector 102 may be varied to accommodate different light sources or to adapt the fixture to an external light source if light source 101 is not present. The fixture as described in FIG. 1 is Configuration A.

FIG. 1 is a side view of a photographic lighting system in accordance with an embodiment above as Configuration A. The photography lighting system includes a light source 101 which is placed behind the reflector 108. As described above in FIG. 1, it may be any kind of light. The light source may be equipped with a reflector 102 that collimates the light. The fixture may include a set of baffles and collimating lens 103 to further collimate the light for the torus shaped dichroic or interference Filter A 104. The torus shaped dichroic or interference Filter A 104 sits on top of the collimating assembly 103. The tube 105, which further collimates the light for the dichroic or interference filter 106 also sits on top of the collimating assembly 103. These components may be configured to fit on the back of the photographic lighting reflector 108, provided with a hole in the base to accommodate light source, collimating assembly and filters.

In an alternative embodiment, the light source 101 may emit light in diverse directions, which then may be collimated before entering the filters. A collimating lens or micro diffusion material may be used to collimate the light, either by itself or in concert with baffles. The torus shaped dichroic or interference Filter A 104 substantially filters all wavelengths of visible light except for a desired band of wavelengths, this embodiment may be specific single narrow bands of the spectrum or multiple narrow bands of the of the spectrum. The light is reflected off the central parabolic surface 107 and then variously reflected again from the dish reflector 108. The resulting light from Filter A is diffused into many paths depending on the angle that any single path emerging from the torus shaped dichroic or interference filter 104 hits the central reflector 107 and subsequently the main reflector 108, producing the soft light 111. The remaining beams of light emitted by the light source 101 are collimated by the tube 105 and pass through the dichroic or interference filter 106.

The dichroic or interference filter 106 substantially filters all wavelengths of visible light except for a desired band of wavelengths, in this embodiment in the Filter B range of the spectrum. On top of the dichroic or interference filter 106 is a diffusion filter 109 which spreads the light passed by the dichroic or interference filter by a measured amount which may be varied to make it usable for normal photography. The hard Filter B light produces lights paths 112. Light paths 111 and 112 may illuminate the object 113. On reaching the object 113, the first light path 111 and the second light path 112 may each have separate photographic qualities from each other, such as, for example, hardness versus softness. The first light path 111 and the second light path 112 may be spectrally distinct. The first light path 111 and the second light path 112 may then be prepared for post-processing techniques in which each light path is treated separately, blended in part or whole or further computed with each other in order to give a photograph a certain quality, such as desired degree of hardness or softness.

In an alternative embodiment the fixture of FIG. 1 may be configured to remove the torus shaped filter A and central Filter B. The embodiment described in FIG. 1 a uses the parabolic reflector 107a to reflect the portion of the spectrum A creating Light Path A 111a and pass the portion of the spectrum B creating Light Path B 112a. The light may be further filtered by the surface of Reflector 108a or by additional filter at 109a. The fixture as described in FIG. la is Configuration B.

In an alternative embodiment the fixture of FIG. 1 may be configured to remove the torus shaped filter A and central Filter B. The embodiment described in FIG. 1 b may include the light source inside the parabolic reflector. A portion of the light from light source 101b passes through Large Filter A 102b which is further diffused by diffusion material 103b. The remaining portion of the light from light source 101b passes through Filter B 104b with very little or no diffusion added.

The combination of Filter 102b, diffusion material 103b and Filter 104 can form a filter assembly to cover the surface of the parabolic reflector 108b. The filter assembly may be fitted to reflector 108b or be larger and detached from reflector 108b. The filter assembly may be used directly with Light Source 101b without reflector 108b or an external light source. A combination of one or more Filter A 102b with diffusion material 103b and one or more Filter B 104b may form any patterns or shape to modify the intensity and direction of Light Source 101b. This may include a checker board, dot or other interleaved patterns of alternating Filter A 102b with diffusion 103b and Filter B 104b as shown in detail 105b. The fixture as described in FIG. 1a is Configuration C.

FIG. 1c is view of a photographic lighting system in accordance with an embodiment above as Configuration A. The photography lighting system includes a light source 101c which is placed behind the reflector 108c. As described above in FIG. 1, it may be any kind of light. The light source may be equipped with a reflector 102c that collimates the light. The fixture may include a set of baffles and collimating lens 103c to further collimate the light for the torus shaped dichroic or interference Filter A 104c. The torus shaped dichroic or interference Filter A 104c sits on top of the collimating assembly 103c. The tube 105c, which further collimates the light for the dichroic or interference filter 106c also sits on top of the collimating assembly 103c. These components may be configured to fit on the back of the photographic lighting reflector 108c, provided with a hole in the base to accommodate light source, collimating assembly and filters. Additional diffusers or beam spreading optics may be added as 109c, 110c. Additional filters and diffusers 111c as described in FIG. 1b may be added.

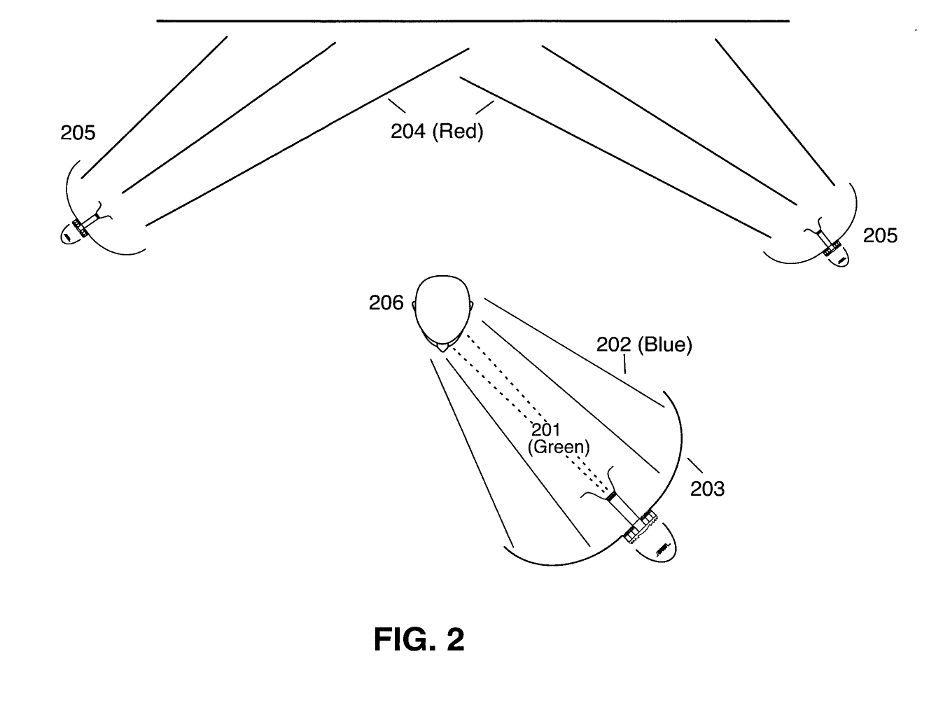

The fixture of FIG. 1 can also be used with specific combinations of color filter or dichroic and/or interference filters, such as red-green (Configuration B) and red-blue (Configuration C), or it can be used in concert with another filtered light source appropriate for background illumination. For example, the fixture with Filter A using blue and Filter B using green modified light can be used with a red filtered background light (Configuration D), or a fixture with Filter A using red and Filter B using green modified light could be used with a Filter C using blue filtered background light (Configuration E), or a fixture with Filter A using red and Filter B using blue modified light could be used with a Filter C using green filtered background light (Configuration F). FIG. 2 illustrates a studio set-up with one dual spectrally multiplexed filtered light fixture and one singly filtered light fixture aimed at the background. The order, sequence and shape of the filters, diffusers, baffles and other optics may be changed to achieve similar effects. The fixture described in FIG. 1 may contain one or more Light Sources, one for each filter and corresponding Light Path. Each Light source may be of a different type and may be internal and fixed in device or from external source. For example, one or more LED lamps may be placed inside Parabolic reflector 107 and Fixture of FIG. 1 adapted to an external Xenon Flash unit. These configurations of filters, reflectors and lights may offer similar functionality. The use of a background light may enable enhancement of aesthetic or special effects desirable in a photograph such as adjustment of shadow and contrast, or for masking and keying applications.

FIG. 2 is an illustration of how the dual spectrally multiplexed lighting fixture described above may be used with one or more lighting fixtures equipped with a single type of color filter, dichroic filter or interference filter which is directed at a background surface. The distribution of the dichroic or interference filters between the two lighting fixtures may take any form as listed above in Configurations A through F. In an embodiment a hard and direct green light (Filter B) 201 and a diffuse blue light (Filter A) 202 emanate from fixture 203 to illuminate object 206. Red light 204 emanates from fixture 205 and provides illumination to a wall or background behind the object being photographed. Post capture editing of this embodiment may entail computing, toggling and/or blending two or more light streams, or otherwise processed in a computer with two or more channels of the captured data.

The light emerges from the fixture 203 in multiple streams 201 & 202, for example one soft or diffuse, the other hard or unidirectional. The light illuminates the object 206 to be photographed and a shot is taken. Circuitry next to the photo sensor converts the light energy to a voltage. Additional circuitry on the chip may be included to convert the voltage to digital data. The unedited image data is entered into a standard photo editing program on a computer, or can be viewed through the built in previewing and editing functions of a DSLR camera, assuming modifications of the camera that will allow that, and that the camera is not configured to blend, combine or otherwise modify the image data. The photographer may then select between the two data streams, one corresponding to the image produced by the blue (Filter A) filtered light, the other produced by the green (Filter B) filtered light, for example, or blend or further process the two or more channels of the captured data in a computer.

In an embodiment, the method and system of the present disclosure spectrally divides light into two or more channels. Multiple light sources can be set up, each one spectrally distinct as filtered by a different dichroic or interference filter. Each light source may have one dichroic or interference filter, or may have two dichroic or interference filters. The two or more light sources give two or more directions of light on the object, hence two or more sets of shadows and highlights. These options can be blended or selected by the photographer or user post capture. The quality of the light from each source can be modified by filters, reflectors or other photographic equipment. The dichroic or interference filters can be attached to the light source in a variety of ways, and this disclosure includes all possible attachments. The embodiment described in FIG. 1 may be made modular, so that each part, for example the filters 104 & 106, the tube 105, the parabolic reflector 107, the collimating assembly 103 and the diffusion filter or other optic 109 may be removed or replaced with other components to make other embodiments.

Two or more of the above figured device may be used in combination. In such as configuration each device with corresponding Light Source may include only Filter A or only Filter B, each being used with from a different position or direction. Such configuration may require all or some of the components to be present in order to achieve the desired characteristics from each Light Path. A configuration using only filter B may not require reflector 108 or reflector 107. A configuration using only Filter A may not require tube 105. Another configuration may use Filter A in both filter positions for one fixture and Filter B in both Filter positions for another fixture. This configuration would allow a mixture of hard and soft light with spectrally distinct light coming from each fixture and fixture position.

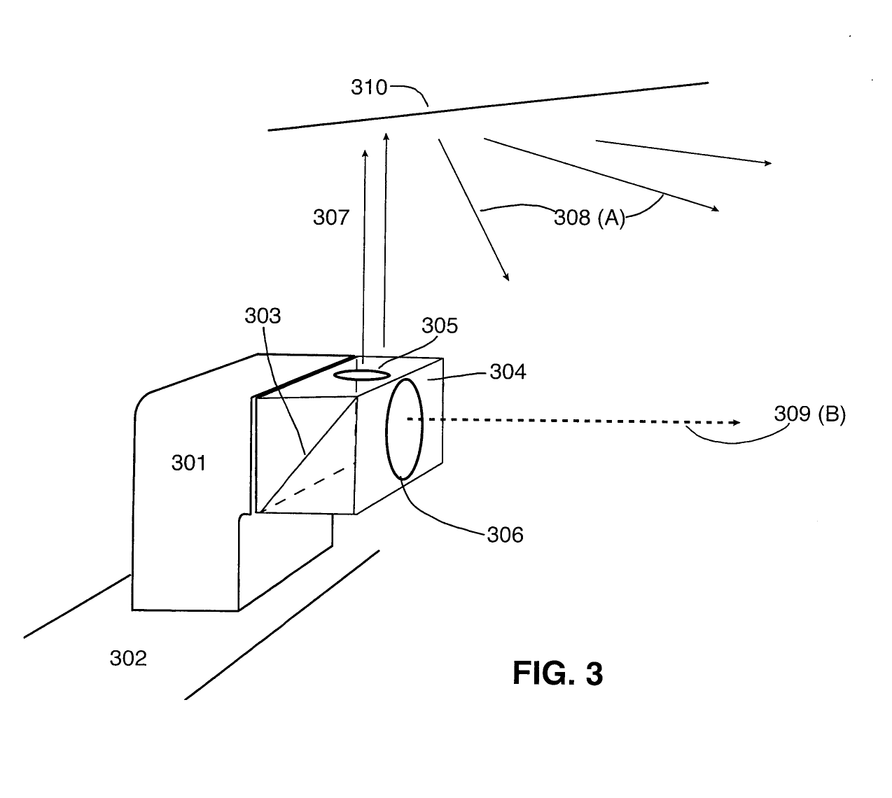

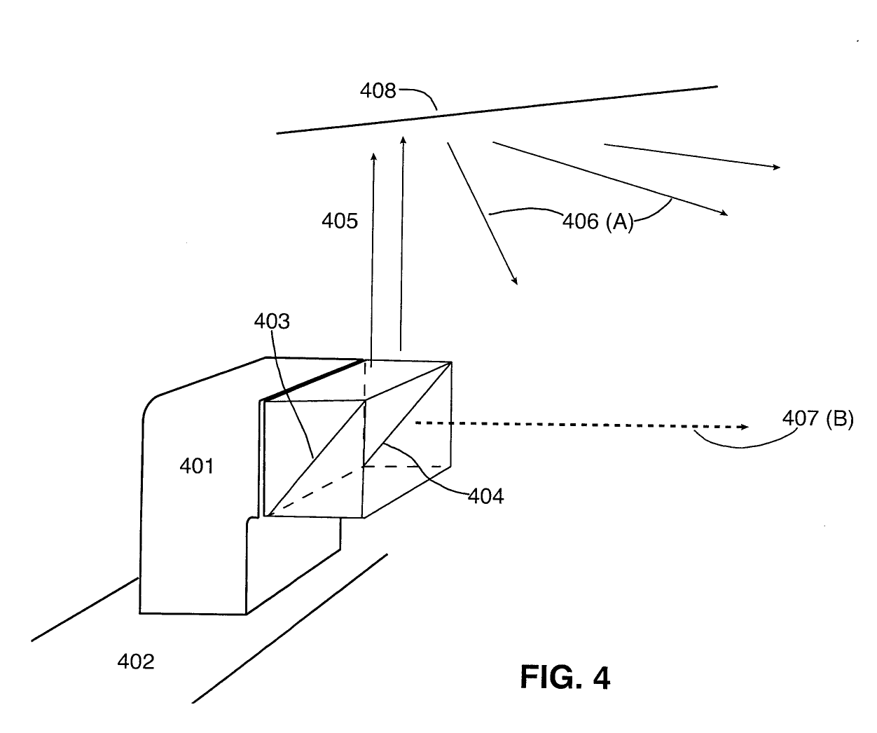

In another embodiment, portable flash units may be attached to a camera, or they may be hand held, or they may have other supports, or flash capability may also be built into a camera but their common feature is that they can be used both within and outside of a photography studio. Flash attachments commonly allow the attachment of diffusers and/or the rotation of the attachment so that the light can be applied either directly or indirectly to the object. The addition of a beam splitter may allow the light from the flash to be sent in two directions at once (FIG. 3). Each beam of light will pass through a dichroic or interference filter differently configured for the camera sensor as in either of the examples above, with the same effect, namely the photographer/user will be able to use editing software or the built in previewing and editing functions of the DSLR camera to toggle between two different kinds of flash lighting.

FIG. 3 illustrates a flash lighting system for photography, in accordance with an embodiment. The flash lighting system may include a flash lighting unit 301. This may be attached to a camera body 302, as in this embodiment, or it may be held by the photographer or attached to a support. A light source 303 emits a flash of light, which strikes a beam splitter 304. The beam splitter 304 reflects a portion of the light upward, and allows the remaining portion of the light to pass straight through. The upward directed light passes through a dichroic or interference filter 305 which substantially filters all wavelengths of visible light except for a desired band of wavelengths, in this embodiment in the Filter A range of the spectrum, making the Light Path A 307. This upward directed light strikes ceiling, walls or other surfaces 310 positioned above the flash device which scatter the light, making diverse paths 308. The remaining light travels through the beam splitter and through a dichroic or interference filter 306, which substantially filters all wavelengths of visible light except for a desired band of wavelengths, in this embodiment in the Filter B range of the spectrum, making the Light Path B 309. The above described assembly FIG. 3 may include one or more light sources or be fitted as an adapter to one or more external light sources and be configured by additional apparatuses. The above described assembly may be built into a camera or capture device and include one or more light sources.

The reflected beams of light 308 and the second beam of light 309 will have separate photographic qualities and be spectrally distinct. For example, the beam of light 309 may be Filter B and hard, whereas the reflected beams of light 308 may be soft/diffuse and Filter A. The beams of light 308 and 309 may then be prepared for post-processing techniques in which each light path is treated separately, and blended, in order to give a photograph a desired quality, such as hardness versus softness.

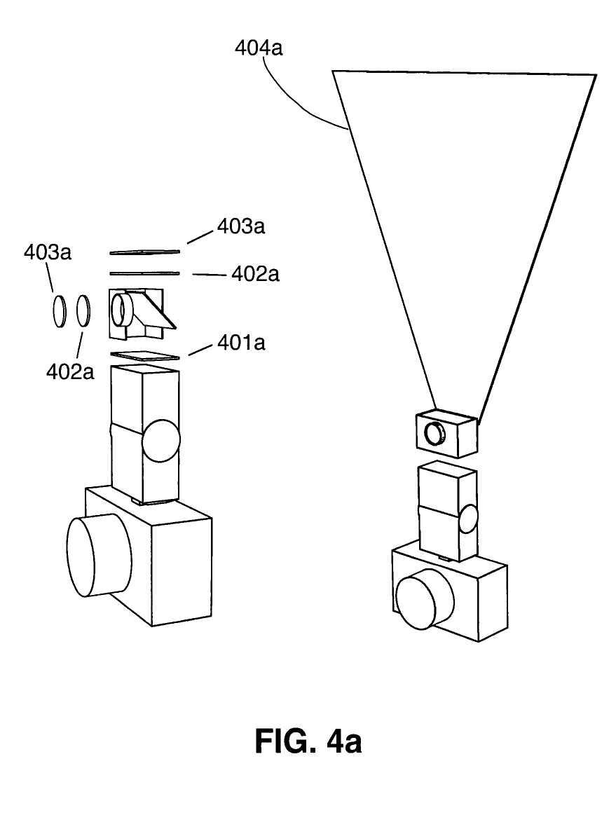

In an alternative embodiment, illustrated in FIG. 4, the beam splitter 404 may itself be a multiple band pass dichroic or interference filter. This disclosure includes arrangements of filters that may pass wavelengths of light at a desired angle, and simultaneously reflect certain wavelengths of light at a desired angle.

In the embodiment illustrated in FIG. 4, a light source 403 emits a flash of light, which strikes dichroic or interference beam splitter 404. The beam splitter 404 may reflect a portion of the light upward, and allow the remaining portion of the light to pass straight through at a desired angle. The upward directed light may be substantially limited to a desired band of wavelengths of light, in this embodiment in the Filter A range of the spectrum, making the Filter A Light Path 405. This upward directed light may strike ceiling, walls or other surfaces 408 positioned above the flash device which scatter the light, making diverse paths 406. The forward directed light, which has passed through the dichroic or interference beam splitter 404, may be substantially limited to a desired band of wavelengths of light, in this embodiment in the Filter B range of the spectrum, making the Filter B light path 407. The reflected beams of light 406 and the second beam of light 407 will have separate photographic qualities and be spectrally distinct. For example, the beam of light 407 may be Filter B and hard, whereas the reflected beams of light 406 may be soft/Diffuse and Filter A. The beams of light 406 and 407 may then be prepared for post-processing techniques in which each light path is treated separately, and blended, in order to give a photograph a desired quality, such as degrees of hardness or softness. The above described assembly FIG. 4 may include one or more light sources or be fitted as an adapter to one or more external light sources. The above described assembly may be built into a camera or capture device and include one or more light sources.

In an alternative embodiment the devices described in FIG. 3 and FIG. 4 may also include additional optical components to further modify the Light Path. FIG. 4a describes these additional components. When the above described device is being adapted to an existing on camera lighting unit or Speedlight it may be required to modify the Light path before reaching the dichroic mirror or filters. For this purpose a collimator or collimating optic 401a is used. The collimator may include both a lens and baffle assembly or may include just a lens or just a baffle to provide the required collimation. An additional collimator may further modify the Light source after passing through the beam splitter, but before reaching Filter A or Filter B.

Additional embodiments may also include the use of an optical beam spreader 402a and additional diffusion material 403a. These additional optics may be used on both Light Path A and Light Path B and order may be switched to achieve the desired beam spread or light intensity. An additional embodiment may also include an additional diffusion panel 404a to receive the light from Light Path A and provide additional diffusion or light intensity.

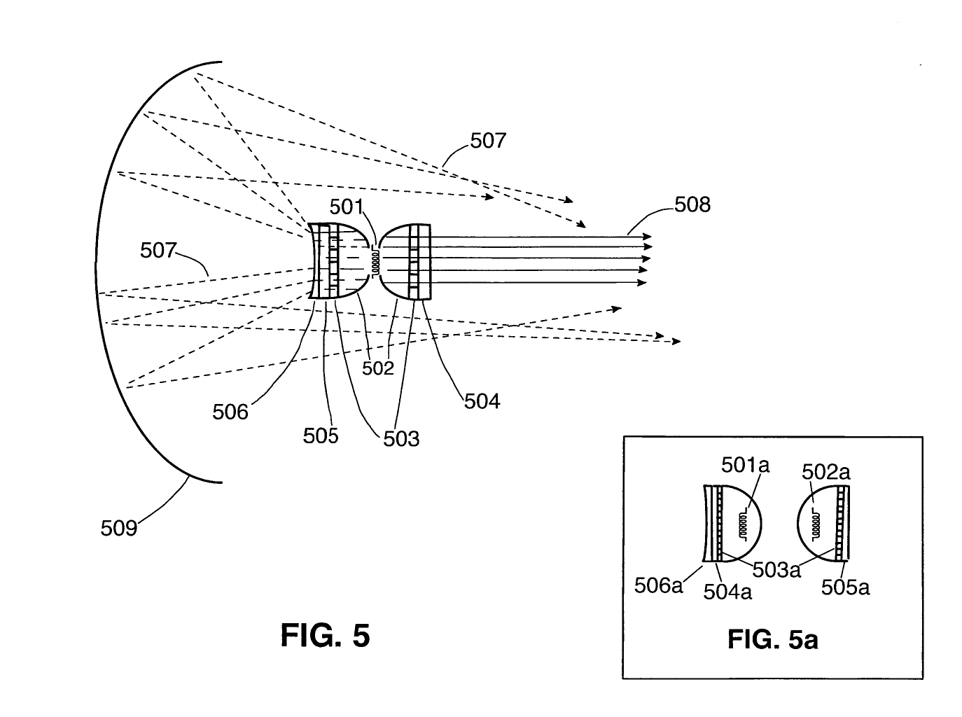

FIG. 5 illustrates a lighting system 500, in accordance with an embodiment. A light source 501 is placed within a photographic reflector 509, which may be made of metal or fabric. The light may be directed both into the reflector 509, from which it may be re-reflected as a diffuse light 507, and away from the reflector 509 as a hard, strongly directional light 508. The light path directed into the reflector may be filtered by a multiple bandpass dichroic or interference filter 505, called the first filter, which substantially filters all wavelengths of visible light except for a desired set of bands of wavelengths. The beam of light directed away from the reflector 509 may be filtered by a multiple bandpass dichroic or interference filter 504, called the second filter, which substantially filters all wavelengths of visible light except for a desired set of bands of wavelengths complementary to and not overlapping those of the first filter 505.

The photographic reflector 509 may be fitted with a light source 501 that sends light into the reflector to be reflected and diffused. The light source 501 may be configured to send light in two directions, both into the reflector 509 and in the opposite direction away from the reflector 509. The lighting system 500 may be fitted with parabolic reflectors 502 oriented in both directions to collimate the light. The lighting system 500 may also be fitted with baffles or optics 503 at both open ends to further collimate or spread the light. The lighting system 500 may be fitted with the second filter 504 on the outward facing end, and the first filter 505 on the inward facing end. As in the embodiment described in FIG. 1 the two filters 504 & 505 may pass complementary and non-overlapping sets of bands of wavelengths of light. The first filter 505 may be fitted with a lens or diffusion filter or other optic 506 to spread the light into the reflector 509. The second filter 504 may produce a hard strongly directional light 508, the first filter 505 may produce a soft diffuse light 507.

In an alternative embodiment, two light sources, 501a & 502a, may be used, one facing into the reflector 509 and one facing outward with Light directed towards objects being photographed. (FIG. 5a). The reflector 509 may be fitted with two light sources, 501a and 502a, facing in opposite directions. Light source 501a may face into the reflector 509 and light source 502a may face outward from the reflector 509. Each light source may have a parabolic reflector to collimate the light and a set of baffles or optics 503a to further collimate or spread the light. As above in FIG. 5 the inward facing light 501a may have a first filter 504a, and a filter or other optic 506a to spread the light. The outward facing light 502a may have a second filter 505a that produces wavelengths of light complementary and not overlapping to those emitted by filter 504a. In another configuration the two independent Light sources 501a & 502a may be pointed in the same direction but at different positions. Light source 501a may be placed behind Reflector 509 and Directed towards 502a, where the back of 502a acts as a parabolic reflector as described in FIG. 1. Each Light source may be of different type Light Source 501a may be Xenon Flash while Light source 502a uses one or more LED lamps. Such a configuration would also enable 502a to act as an ambient modeling lamp to preview the effect and direction of Light Source from fixture. This disclosure includes one or two lights in concert with single or multiple bandpass dichroic or interference filters that may produce multiple independent channels of light.

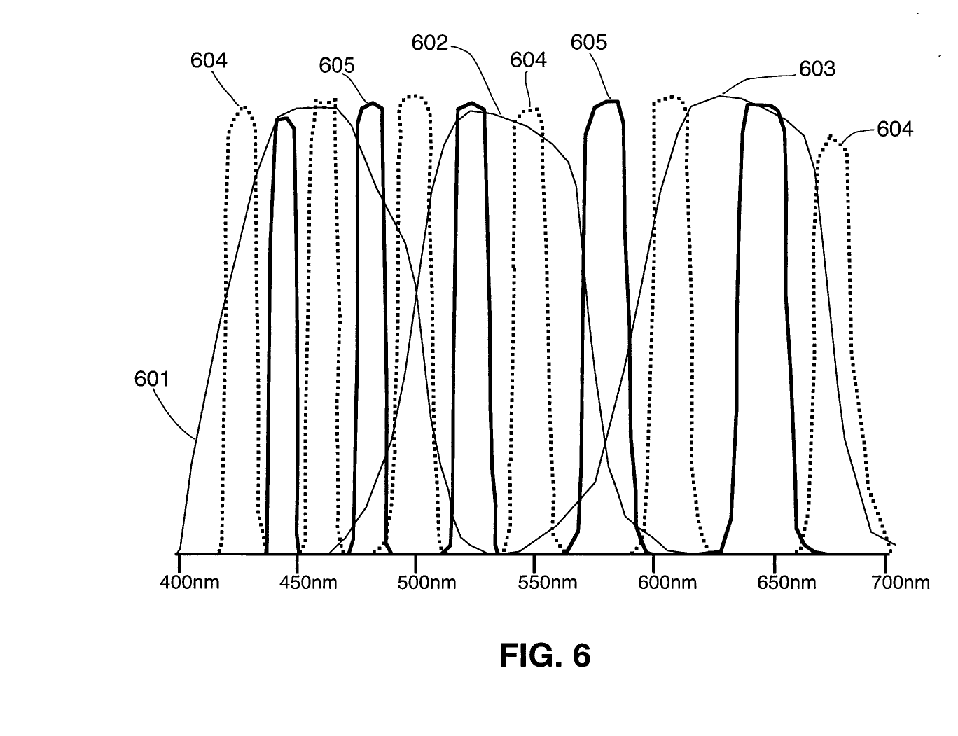

FIG. 6 illustrates a spectrum of light 606, visible to a human, in accordance with an embodiment. The spectrum of light 606 includes a range of wavelengths from approximately 400 to approximately 800 nanometers. Within the spectrum of light 606 there are discrete bands that correspond to the capacity of camera sensors. Ranges of sensitivity to red, green and blue can be plotted as curves 607. In FIG. 6, curves 601, 602 and 603 correspond to the red, green and blue areas of the spectrum as they are registered on camera sensors. The curve of sensitivity to red is 601, the curve of sensitivity to green is 602 and the curve of sensitivity to blue is 603.

Bands of wavelengths may be isolated and managed separately through the use of multiple bandpass dichroic or interference filters. A dichroic or interference filter may pass or reflect more than one discrete band of wavelengths of light. In FIG. 6, 604 represents bands of wavelengths passed by a single dichroic or interference filter and distributed across the spectrum so that bands correspond to certain of the red bands captured by camera sensors, bands correspond to certain of the green bands captured by camera sensors and bands correspond to certain of the blue bands captured by camera sensors. A complementary multiple bandpass filter 605 may pass the remaining bands; bands in the red area of the spectrum, bands in the green area of the spectrum and bands in the blue area of the spectrum. The two sets of bands of wavelengths of light, 604 & 605 may be configured so that they do not overlap. Combined, two multiple bandpass dichroic or interference filters manufactured to pass complementary bands of wavelengths may pass all of the wavelengths of visible light that can be captured by camera sensors while dividing the complete spectrum into two channels that may be manipulated independently. This drawing is to explain the principle of how complementary multiple bandpass filters can be made to enable discrete channels in color photography. It does not resemble an embodiment in any particulars, for example the precise spectra of the bands of wavelengths passed by either filter, the number of possible bands to be placed on either filter or any other element necessary to the functioning of the system. The precise wavelengths to be passed by the dichroic or interference filters, in an embodiment, will depend on the sensitivity of the particular camera sensor or sensors to be filtered and on the characteristics of the object to be photographed. Each of the complementary non-overlaping spectrums may be used for Filter designated as Filter A and Filter B in FIG. 1, FIG. 3 and FIG. 4. When such set of filters is used with capture device with one or more RGB sensors the result will allow up to six independent channels to be captured and provide dual RGB images for use with full color Multiplexed Lighting System.

Filters Designated as Filter A and Filter B in above description may be of any specific spectral character. For many common standard RGB Bayer filtered sensors ideal embodiment of Filter A would be a Short pass “Blue” filter with a sharp cut at wavelengths in the range of 440 nm-470 nm. An Ideal embodiment of Filter B would be a narrow Bandpass “Green” filter with a Bandwidth of 5 nm-20 nm in the range of 550 nm-570 nm. An ideal embodiment of Filter C would be a long pass “Red” Filter with a sharp cut at 720 nm-740 nm. An alternative embodiment of Filter A would be a multiband “Magenta” Filter with Shortpass in range of 440 nm-470 nm and Long pass of 720 nm-740 nm and block in in the range between 440 nm-470 nm and 720 nm-740 nm.

Thus, in a first aspect, there is disclosed a photo/video lighting system, comprising: a first filter adapted to selectively pass a first spectrum of light emitted from at least one light source along a first light path; and a second filter adapted to selectively pass a second spectrum of light emitted from the at least one light source along a second light path; wherein, the first and second filters produce at least two spectrally distinct light streams along the first light path and the second light path, each light stream having different lighting characteristics.

In an embodiment, the photo/video lighting system further includes the least one light source.

In another embodiment, the at least one light source is one of a tungsten filament, a fluorescent tube, a photo/video flash tube, or one or more phosphors.

In another embodiment, the photo/video lighting system further comprises a reflector for reflecting at least a portion of light emitted from the at least one light source to emit light along the first and second light paths.

In another embodiment, the reflector is positioned after at least one of the first filter in the first light path or the second filter in the second light path.

In another embodiment, the at least one reflector is adapted to reflect diffuse light which has a different lighting characteristic than direct light emitted by the at least one light source.

In another embodiment, the at least one reflector comprises a first parabolic flared cylinder reflector adapted to reflect light onto a main parabolic reflector.

In another embodiment, the first filter is a circular filter, and the second filter is a toroid filter surrounding the first filter.

In another embodiment, all components are housed within a self-contained, portable lighting device.

In another embodiment, a second light source is placed inside a first parabolic reflector in within larger parabolic reflector.

In another embodiment, the photo/video lighting system further comprises one or more photo/video sensors adapted to be sensitive to at least two spectrally distinct light streams having different lighting characteristics.

In another embodiment, the first filter is adapted to pass a direct light stream, and the second filter is adapted to pass a diffuse light stream, and the one or more photo/video sensors are adapted to simultaneously capture both first and second light streams with different lighting characteristics.

In another embodiment, the different lighting characteristics include one or more of hard/soft, warm/cool, and direct/indirect.

In another embodiment, the first filter is adapted to pass a direct green light stream and the second filter is adapted to pass a diffuse blue light stream.

In another embodiment, the first and second filters are one of a dichroic filter or an interference filter.

In another embodiment, the first filter and the second filter are configured to pass complementary, non-overlapping bands of wavelengths.

In another embodiment, the photo/video lighting system further comprises a photo/video sensor adapted to capture images of a subject illuminated by the complementary, non-overlapping bands of wavelengths passed by the first filter and the second filter.

In another embodiment, the captured images are adapted for post capture editing to toggle or blend the complementary, non-overlapping bands of wavelengths passed by the first filter and the second filter.

In another embodiment, the photo/video sensor is adapted to capture color images of a subject illuminated by the complementary, non-overlapping bands of wavelengths passed by the first filter and the second filter.

In another embodiment, the photo/video lighting system further comprises at least two light sources having different lighting characteristics.

In another embodiment, the at least two light sources include a continuous light source and an instantaneous flash light source.

In another embodiment, the photo/video lighting system further includes a toggle to allow an operator to switch between lighting modes, or a combination of lighting modes.

In another embodiment, the first filter and the second filter are replaceable with filters having different filter characteristics.

In another embodiment, the at least two light sources are configured in a self-contained, portable lighting device.

In another aspect, there is provided a method for performing photo/video lighting in accordance with any one of the system embodiments described above.

While various examples have been described above by way of illustration, it will be apparent to one skilled in the art that alternations, modifications and variations can be effected to the particular illustrative embodiments by those of skill in the art without departing from the scope of the invention, as defined by the claims appended hereto.

1. A photo/video lighting system, comprising:
a first filter adapted to selectively pass a first spectrum of light emitted from at least one light source along a first light path; and
a second filter adapted to selectively pass a second spectrum of light emitted from the at least one light source along a second light path;
wherein, the first and second filters produce at least two spectrally distinct light streams along the first light path and the second light path, each light stream having different lighting characteristics.

2. The photo/video lighting system of claim 1, further including the least one light source.

3. The photo/video lighting system of claim 2, wherein the at least one light source is one of a tungsten filament, a fluorescent tube, a photo/video flash tube, or one or more phosphors.

4. The photo/video lighting system of claim 2, further comprising a reflector for reflecting at least a portion of light emitted from the at least one light source to emit light along the first and second light paths.

5. The photo/video lighting system of claim 4, wherein the reflector is positioned after at least one of the first filter in the first light path or the second filter in the second light path.

6. The photo/video lighting system of claim 4, wherein the at least one reflector is adapted to reflect diffuse light which has a different lighting characteristic than direct light emitted by the at least one light source.

7. The photo/video lighting system of claim 5, wherein the at least one reflector comprises a first parabolic flared cylinder reflector adapted to reflect light onto a main parabolic reflector.

8. The photo/video lighting system of claim 7, wherein the first filter is a circular filter, and the second filter is a toroid filter surrounding the first filter.

9. The photo/video lighting system of claim 1, wherein all components are housed within a self-contained, portable lighting device.

10. The photo/video lighting system of claim 1, further comprising one or more photo/video sensors adapted to be sensitive to at least two spectrally distinct light streams having different lighting characteristics.

11. The photo/video lighting system of claim 10, wherein the first filter is adapted to pass a direct light stream, and the second filter is adapted to pass a diffuse light stream, and the one or more photo/video sensors are adapted to simultaneously capture both first and second light streams with different lighting characteristics.

12. The photo/video lighting system of claim 11, wherein the different lighting characteristics include one or more of hard/soft, warm/cool, and direct/indirect.

13. The photo/video lighting system of claim 11, wherein the first filter is adapted to pass a direct green light stream and the second filter is adapted to pass a diffuse blue light stream.

14. The photo/video lighting system of claim 11, wherein the first and second filters are one of a dichroic filter or an interference filter.

15. The photo/video lighting system of claim 11, wherein the first filter and the second filter are configured to pass complementary, non-overlapping bands of wavelengths.

16. The photo/video lighting system of claim 13, further comprising a photo/video sensor adapted to capture images of a subject illuminated by the complementary, non-overlapping bands of wavelengths passed by the first filter and the second filter.

17. The photo/video lighting system of claim 16, wherein the captured images are adapted for post capture editing to toggle or blend the complementary, non-overlapping bands of wavelengths passed by the first filter and the second filter.

18. The photo/video lighting system of claim 17, wherein the photo/video sensor is adapted to capture color images of a subject illuminated by the complementary, non-overlapping bands of wavelengths passed by the first filter and the second filter.

19. The photo/video lighting system of claim 1, further comprising at least two light sources having different lighting characteristics.

20. The photo/video lighting system of claim 19, wherein the at least two light sources include a continuous light source and an instantaneous flash light source.

21. The photo/video lighting system of claim 19, wherein the system includes a toggle to allow an operator to switch between lighting modes, or a combination of lighting modes.

22. The photo/video lighting system of claim 19, wherein the first filter and the second filter are replaceable with filters having different filter characteristics.

23. The photo/video lighting system of claim 19, wherein the at least two light sources are configured in a self-contained, portable lighting device.

24. A method for performing photo/video lighting in accordance with claim 1.
